(19) United States
(12) Patent Application Publication
(10) Pub. No.: US 2020/0092304 A1
(43) Pub. Date: Mar. 19, 2020

(54) MALWARE DETECTION SYSTEM

(71) Applicant: Walmart Apollo, LLC, Bentonville, AR (US)

(72) Inventors: Rohit SEHGAL, Bengalore (IN); Nishit MAJITHIA, Bengalore (IN)

(73) Assignee: Walmart Apollo, LLC, Bentonville, AR (US)

(21) Appl. No.: 16/569,904

(22) Filed: Sep. 13, 2019

Related U.S. Application Data
(60) Provisional application No. 62/778,973, filed on Dec. 13, 2018.

(30) Foreign Application Priority Data
Sep. 14, 2018 (IN) 201811034764

(51) Int. Cl. H04L 29/06; H04L 9/32

(52) U.S. Cl. CPC H04L 63/145; H04L 63/1491; H04L 63/1433; H04L 9/3234

(57) ABSTRACT

A method of identifying a malware compromise is provided. The method includes: generating a new entry of fake token for a non-existing application or an existing application; storing the fake token in a same location as a genuine token of a computing device; detecting when the fake token is accessed and used by a malware for logging into a server on which the existing application is installed; and issuing a notification when the server is accessed with the fake token.

### CROSS-REFERENCE TO RELATED APPLICATIONS

This patent application claims the priority to Indian Provisional Patent Application No.: 201811034764, filed Sep. 14, 2018, and U.S. Provisional Application No. 62/778,973, filed Dec. 13, 2018, contents of which are incorporated by reference herein.

### BACKGROUND

### 1. Technical Field

The present disclosure relates to computer security technology, and more specifically to a system and method of identifying malware compromises in a computing device.

### 2. Introduction

Connectivity of mobile devices to the Internet has increased, which may expose vulnerabilities associated with mobile applications. Adversaries may identify some ways to exploit these vulnerabilities, for example, using malware for mobile devices to gain access to the devices. Further it is not feasible to run complex security models on these light weight devices such as smart phones, or computing tablets. Therefore, there is a need for simple and effective security solutions to such threats.

### SUMMARY

A system for performing concepts disclosed herein can include a computing device. The computing device is configured to: generate a fake token; store the fake token in a same location as a genuine token of the computing device, and send the fake token to a server. The system further can include the server in communication with the computing device and configured to: receive the token; verify the fake token against a server login routine; detect an access attempt of the server with the fake token by a malware when the verification of the fake token fails; and issue a notification when the access attempt with the fake token is detected. The access attempt of the server can include an access attempt of an existing application with the fake token or an access attempt of a non-existing application with the fake token.

A method for performing concepts disclosed herein can include generating a new entry of fake token for a non-existing application or an existing application; storing the fake token in a same location as a genuine token of a computing device; detecting when the fake token is accessed and used by a malware for logging into a server on which the existing application is installed; and issuing a notification when the server is accessed with the fake token.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary system of identifying malware compromises in computing devices, in accordance with one embodiment;

FIG. 2 illustrates an exemplary method of identifying malware compromises in computing devices, in accordance with one embodiment; and

FIG. 3 illustrates an exemplary computer system that may implement a portion of the system in FIG. 1 and the method in FIG. 2.

### DETAILED DESCRIPTION

Systems, methods, and computer-readable storage media configured according to this disclosure are capable of identifying malware compromises in computing devices, such as mobile devices. Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. For example, as will be described in the below, identification of malware compromises is described in situations of post exploitation based on fake token technique, but may also be applied to situations of post exploitation based on other authentications such as passwords. Further, the below descriptions are focused on Android applications, but may also be applicable to Linux-based applications, and other operating system-based applications.

In a computing device, authentication in an application may take place using authorization tokens (referred to as genuine tokens herein). Malware can try to access the tokens to compromise the application. Authorization tokens may be stored in a folder on the device. In this disclosure, a fake token of the genuine token may be generated and also stored in the same location on the device as the genuine token. The fake token may refer to the same application as the genuine token. The application may be installed on a computer server that may communicate with the device via wired or wireless networks. The fake token may also refer to a non-existing application. Attacking malware will typically access tokens in the folder randomly. If there are only two tokens (i.e., the genuine token and the fake token) present in the same location of the folder on the device, there is a 50% chance that the fake token will be selected by the malware. And once the device is compromised and the fake token is accessed and used on the server, for example, for the non-existing application, an alarm can be raised, as this action using the fake token represents a malicious activity. Thus, breach of the device may be detected.

In a case where the genuine token and the fake token are associated with a same application on the computer server, the application can determine that the fake token has been accessed and that the application has been compromised. The higher the number of fake tokens, the greater the chances of detecting an attack or compromise. Embodiments of the invention can detect breaches with an accuracy of at least 50%.

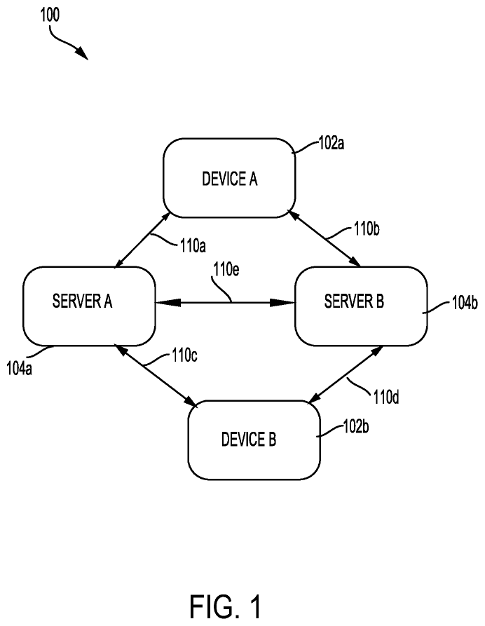

The disclosure now turns to FIG. 1. FIG. 1 shows an exemplary system 100 for identifying malware compromises on computing devices, in accordance with one embodiment. The system 100 may comprise one or more client devices 102, for example device A 102a and device B 102b. The system 100 may also comprise one or more computer servers 104, for example, server A 104a and server B 104b. The devices 102 and servers 104 may communicate one another via communications networks 110, for example, 110a, 110b, 110c, and 110d.

The devices 102a and 102b may be any computing device, such as a mobile phone, a computing tablet, or a laptop computer, which may run an operating system, such as Android.

The servers 104a and 104b may be any computing devices, such as desktop computers, laptop computers, dedicated computer servers, mainframes, etc. Various operating systems and applications, such as Linux, Windows operating system, database, may be installed on the servers 104a and 104b. Further the server 104a may store information about the devices 102a and 102b. The server 104b may check user account login information, such as login information of users who use the devices 102a and 102b. These users may create user accounts that may be stored on the server 104b. In some embodiments, information about the devices 102a and 102b, and account login information may be stored on one server, instead of two different servers.

The communications networks 110 may be any wired and/or wireless communication networks, such as WIFI, Bluetooth, near field communications, Internet, etc. The communications among the servers 104a and 104b, the devices 102a and 102b, may be encrypted and authenticated.

In some embodiments, root-based attacks may be used for mobile devices 102a, 102b running Android systems. Malware may exploit vulnerabilities to access temporal or permanent root. The malware may install itself in the devices, 102a and 102b with the help of a malicious application. After compromising the devices 102a and/or 102b, the malware or devices may send control data to command and control the server 104a to fetch the root-kits.

After deploying the root-kits, the malware may mimic user behavior to applications on the devices. Those malicious activities may allow to: steal an authentication token, alter the data with the other applications from an application store, or generate revenue by injecting advertisements.

Authentication tokens provide the way of accessing apps and related services on the behalf of a user. For example, application based services that require login, may not store passwords into devices 102a, 102b, rather they store authentication tokens on devices 102a, 102b. An authentication token may be generated once, when the user enter a password for the first time in the application. From the next consecutive time, to access login based services, the application uses previously generated authentication token to authenticate the user. Once the authentication token is compromised by a hacker, then this authentication token can be used to get access to the login based services on behalf of the user. This may allow the hacker to bypass the login process, if the user is already logged in.

In the system of FIG. 1, fake tokens may be used to make the above-described compromises detected and identifiable. The fake tokens may have no function unless they are selected by a hacker. In this exemplary embodiment, a fake token may be associated with each user's account, for example, in a folder such as in /etc/passwd with corresponding entry in /etc/shadow on the devices 102a and 102b. The fake token may or may not be hashed. The hacker who gets access to this file may try to invert the hashes and use the inverted hashed fake token to login to the computer server 104a for obtaining authorized information or applications.

The server 104b may be configured to perform as login checker. Upon logging into the server 104a using the fake token, the server 104b may check or verify the fake token by using a login routine. The login routine may comprise system-specific or user-specific parameters, such as user's age, location, profession, associated applications installed on the server 104a, etc. The fake token may be checked against those parameters. The fake token may not pass the checking or verification of the login routine, as such, the interactions between the fake token and the login checker may indicate the activity that is malicious and perhaps unauthorized. Thus, with the login using the fake token, an alarm may be raised. This may save the system 100 from being exploited and create a trap for the hacker. As can be seen, if only one genuine token and one fake token are in the device, a chance of adversary getting into the system 100 is 50%.

In some embodiments, more than one fake token may be generated and stored on the device (e.g., devices 102a, 102b) for each user account and/or each application installed on the server 104a, which may improve the chances to catch an adversary. The fake tokens may be associated with applications installed on the server 104a. The fake tokens may also not be associated with any application installed on the server 104a. That is, the fake tokens are just tokens for non-existing applications. The fake tokens may be similar to the genuine tokens in the format, style, etc. and may be generated using various algorithms. For example, the fake tokens may be obtained by tweaking the characters in the selected positions of the corresponding genuine tokens. Such similarity between the genuine token and the fake token may make it difficult for an adversary to distinguish the fake token from the genuine token.

When an intrusion is detected, a notification may be sent to an administrator of the servers 104a and/or 104b, or to other parties (e.g., a user of the devices 102a or 102b). Depending on the security policy applied, the server 104b may or may not reply to the server 104a when a login is attempted. When the server 104b detects that a fake toke is used for the login attempt, it may signal to the server 104a that login should be denied. Also the server 104b may merely signal a silent alarm to an administrator and have the administrator to make a decision of whether the login should be denied.

The security policy applied may comprise: setting off an alarm or notifying a system administrator; notifying a user of the devices 102a or 102b; letting login proceed as usual; letting the login proceed, but on the server 104b only; tracing the source of the login; turning on additional logging of the user's activities; shutting down that user's account; and shutting down the server 104a. The security policy may be installed on the server 104b. The security policy may be activated upon detection of a login attempt using a fake token.

Specifically, in the system 100, a fake token may be an OAuth token. Some malware such as Gooligan, may target only Google OAuth tokens. In such a case, a fake token similar to OAuth tokens that are present in accounts.db, may be added in to the directory /data/system/users/0/ on the devices 102a and 102b. In simple terms, a fake OAuth token for a non-existing application can be installed in the device directory. And once the device is compromised and the fake OAuth tokens are accessed and used on the servers 104a and/or 104b for the non-existing application, the alarm can be raised, as this represents the malicious activity. Adversary may not check if the application is installed in the server 104a or not. They may just try to use the tokens to steal every bit of information.

If a new entry of OAuth token is created for the non-installed application in the system 100, there are 100% chances of exploitation of the fake token to entrap the adversary. If only one fake entry for the corresponding installed application is created, as discussed, there are 50% chances of identification of breaching.

In some embodiments, the server 104b as login checker may record OAuth token access service that may store the parameters to identify the account breaching. These parameters can be a list of installed apps or user's Google app suit information, etc. By recording the OAuth token access service, activities of the OAuth token access service can be tracked. As such, the device that is compromised may be identified.

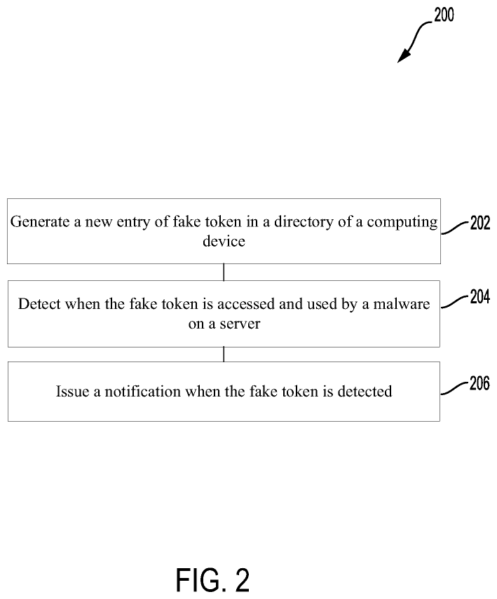

FIG. 2 shows an exemplary method 200 of identifying malware compromises on computing devices. The method 200 may be implemented in the above disclosed systems, and may include the following steps. Some details may refer to the above description of the system 100.

At step 202, a new entry of fake token may be created. The fake token may be associated with an application installed on a server. The fake token may be similar, such as in format and style, to a genuine token associated with the application. The fake token and the genuine token may be stored in a directory of a client device that may use tokens to access the application on the server. The directory may be the directory /data/system/users/0/. The fake token may be a token created for a non-existing application on the server. The fake token also may be an OAuth token used to access Google applications. More than one fake token may be created for one application on the server, or for non-existing application.

At step 204, it is detected when the fake token is accessed and used on a server. An adversary may use malware to pick a token randomly from the client device and use this token to login to the server. The token may be checked by another server as login checker using a login routine. The login routine may comprise system-specific or user-specific parameters, for example, name of a user on the client device, age of the user, location of login, serial number of the client device, etc. By failing to pass the check of the login routine, the token may be determined as a fake token. The fake token may be for the non-existing application, or for the application installed on the server. When the token is determined as a fake token, a breach or compromise of the client device may be detected.

At step 206, a notification may be issued when use of the fake token is detected. The notification signal may be sent to an administrator of the server or to other parties (e.g., a user of the devices). Depending on the security policy applied, the login checker server may or may not reply to the application server when a login is attempted. When the login checker server detects that a fake toke is used for the login attempt, it may signal to the application server that login should be denied. Also the login checker server may merely signal a silent alarm to an administrator and leave the decision to the administrator.

The security policy applied may comprise: setting off an alarm or notifying a system administrator; notifying a user of the device; letting login proceed as usual; letting the login proceed, but on the login checker server only; tracing the source of the login; turning on additional logging of the user's activities; shutting down that user's account; and shutting down the application server.

In some embodiments, the method 200 may further comprise using a login token access service to track and store parameters of the account breach. The parameters can be a list of installed apps or user's Google app suit information, etc. The parameters may be used to identify the device that is compromised. The parameters may also be used to determine which application the hacker tried to attack and what information the hacker tried to collect.

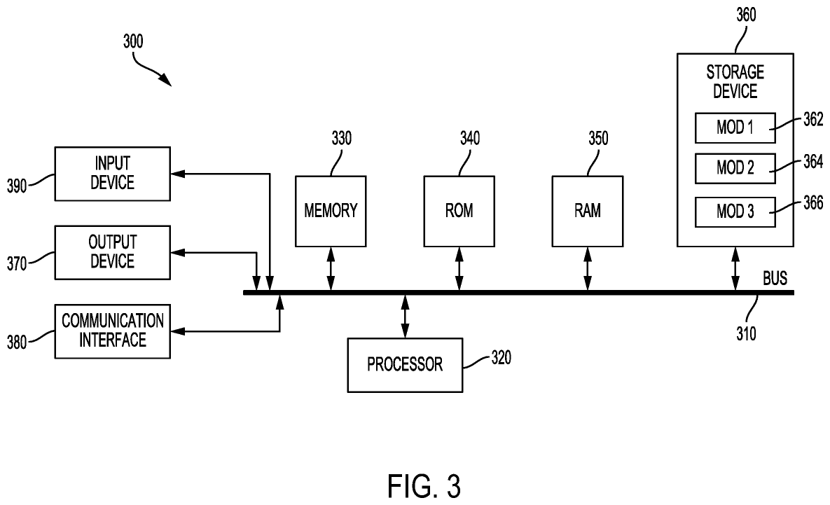

With reference to FIG. 3, an exemplary system 300 is shown that may implement a portion of the system 100 and/or the method 200. The system 300 can include a processing unit (CPU or processor) 320 and a system bus 310 that couples various system components including the system memory 330 such as read only memory (ROM) 340 and random access memory (RAM) 350 to the processor 320. The system 300 can include a cache of high speed memory connected directly with, in close proximity to, or integrated as part of the processor 320. The system 300 copies data from the memory 330 and/or the storage device 360 to the cache for quick access by the processor 320. In this way, the cache provides a performance boost that avoids processor 320 delays while waiting for data. These and other modules can control or be configured to control the processor 320 to perform various actions. Other system memory 330 may be available for use as well. The memory 330 can include multiple different types of memory with different performance characteristics. It can be appreciated that the disclosure may operate on a computing device 300 with more than one processor 320 or on a group or cluster of computing devices networked together to provide greater processing capability. The processor 320 can include any general purpose processor and a hardware module or software module, such as module 1 362, module 2 364, and module 3 366 stored in storage device 360, configured to control the processor 320 as well as a special-purpose processor where software instructions are incorporated into the actual processor design. The processor 320 may essentially be a completely self-contained computing system, containing multiple cores or processors, a bus, memory controller, cache, etc. A multi-core processor may be symmetric or asymmetric.

The system bus 310 may be any of several types of bus structures including a memory bus or memory controller, a peripheral bus, and a local bus using any of a variety of bus architectures. A basic input/output (BIOS) stored in ROM 340 or the like, may provide the basic routine that helps to transfer information between elements within the computing device 300, such as during start-up. The computing device 300 further includes storage devices 360 such as a hard disk drive, a magnetic disk drive, an optical disk drive, tape drive or the like. The storage device 360 can include software modules 362, 364, 366 for controlling the processor 320. Other hardware or software modules are contemplated. The storage device 360 is connected to the system bus 310 by a drive interface. The drives and the associated computer-readable storage media provide nonvolatile storage of computer-readable instructions, data structures, program modules and other data for the computing device 300. In one aspect, a hardware module that performs a particular function includes the software component stored in a tangible computer-readable storage medium in connection with the necessary hardware components, such as the processor 320, bus 310, display 370, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 300 is a small, handheld computing device, a desktop computer, or a computer server.

Although the exemplary embodiment described herein employs the hard disk 360, other types of computer-readable media which can store data that are accessible by a computer, such as magnetic cassettes, flash memory cards, digital versatile disks, cartridges, random access memories (RAMs) 350, and read only memory (ROM) 340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system of identifying a malware compromise, comprising:
a computing device configured to:
generate a fake token;
store the fake token in a same location as a genuine token of the computing device; and
send the fake token to a server; and
the server in communication with the computing device and configured to:
receive the fake token;
verify the fake token against a server login routine;
detect an access attempt of the server with the fake token by a malware when the verification of the fake token fails;
and
issue a notification when the access attempt with the fake token is detected,
wherein the access attempt of the server comprises an access attempt of an existing application with the fake token or an access attempt of a non-existing application with the fake token.

2. The system of claim 1, wherein the fake token is a first fake token and the computing device is further configured to generate a second fake token for the existing application or the non-existing application.

3. The system of claim 1, wherein the fake token is similar to a genuine token of the existing application.

4. The system of claim 1, wherein the notification is sent out to a user of the computing device.

5. The system of claim 1, wherein the server includes a first server and a second server, the second server being configured to:
communicate with the first server and the computer device; and
facilitate detecting the access attempt of the first server with the fake token by the malware.

6. The system of claim 1, wherein the login routine includes system-specific or user-specific parameters.

7. A method of identifying a malware compromise, comprising:
generating a new entry of a fake token for a non-existing application or an existing application;
storing the fake token in a same location as a genuine token of a computing device;
detecting when the fake token is accessed and used by a malware for logging into a server on which the existing application is installed; and
issuing a notification when the server is accessed with the fake token.

8. The method of claim 7, wherein the fake token is a first fake token and the method further comprising generating a second fake token for the existing application or the non-existing application.

9. The method of claim 7, wherein the fake token is similar to a genuine token of the existing application.

10. The method of claim 7, wherein the method further comprising sending out the notification to a user of the computing device.
